(19) United States
(12) Patent Application Publication
(10) Pub. No.: US 2018/0181952 A1
(43) Pub. Date: Jun. 28, 2018

(54) DYNAMIC PORTABLE COMMUNICATION SYSTEM

(71) Applicant: VISA International Service Association, San Francisco, CA (US)

(72) Inventors: Martin Enriquez, San Francisco, CA (US); Chandra Srivastava, San Francisco, CA (US)

(73) Assignee: VISA International Service Association, San Francisco, CA (US)

(21) Appl. No.: 15/738,572

(22) PCT Filed: Jun. 30, 2016
(86) PCT No.: PCT/US16/40412

§ 371 Date: Dec. 20, 2017

Related U.S. Application Data
(60) Provisional application No. 62/186,595, filed on Jun. 30, 2015.

(51) Int. Cl. G06Q 20/36; G06Q 30/02

(52) U.S. Cl. CPC G06Q 20/3674; G06Q 30/0226

(57) ABSTRACT

Disclosed is a system, process and protocol for communicating between a vehicle and an additional communication device using a variety of communication forms.

### CROSS-REFERENCE TO RELATED APPLICATION

This application is the U.S. national stage application of the international patent application under Patent Cooperation Treaty, serial number PCT/US2016/040412, filed on Jun. 30, 2016, which claims priority to a U.S. provisional patent application, Ser. No. 62/186,595, filed on Jun. 30, 2015, whose application are incorporated by reference herein in their entirety.

### BACKGROUND

Wireless communication continues to improve over time. More and more devices have wireless capabilities and users become more and more accustomed to devices being wirelessly enabled. At the same time, wireless communication may cause frustrations when a signal is weak or trust cannot be established.

### SUMMARY

Disclosed is a system, process and protocol for communicating between a vehicle and an additional communication device using a variety of communication forms. The process may use a protocol to establish communication with a vehicle using a first communication form, establish communication with a vehicle using a second communication form, communicate a first section of the communication using the first communication form and communicate a second section of the communication using the second communication form. The protocol may use application program interfaces such that a variety of applications may be able to interface with the process and system.

### BRIEF DESCRIPTION OF THE DRAWINGS

The invention may be better understood by references to the detailed description when considered in connection with the accompanying drawings. The components in the figures may not necessarily be to scale, emphasis instead being placed upon illustrating the principles of the invention. In the figures, like reference numerals designate corresponding parts throughout the different views.

FIG. 1 is an illustration of a process of determining whether a delivery of a package is appropriate to be made to a user based on payment data according to one embodiment of the invention;

FIG. 2 is an illustration of the first communication form and the second communication form according to one embodiment of the invention;

FIG. 3 is an illustration of an extensible protocol according to one embodiment of the invention;

FIG. 4 is an illustration of a partially extensible protocol according to one embodiment of the invention;

FIG. 5 is an illustration of a vehicle at a fueling station taking a payment and using a loyalty program according to one embodiment of the invention;

FIG. 6 is an illustration of a vehicle at a fueling station using multiple communication forms for taking a payment and using a loyalty program according to one embodiment of the invention;

FIG. 7 is an illustration of a vehicle at a fueling station using tokens as part of a payment system and using a loyalty program according to one embodiment of the invention;

FIG. 8 is an illustration of using a computing device in a vehicle to enroll in a redemption platform according to one embodiment of the invention;

FIG. 9 is an illustration of a vehicle at a fueling station using a payment system and using a loyalty program according to one embodiment of the invention;

FIG. 10 is an illustration of a vehicle at a fueling station using multiple communication forms for taking a payment and using a loyalty program according to one embodiment of the invention;

FIG. 11 is an illustration of a vehicle at a fueling station using multiple communication forms for taking a payment and using a loyalty program to pay for a purchase according to one embodiment of the invention;

FIG. 12 is an illustration of using a computing device in a vehicle to use offers as part of a redemption platform according to one embodiment of the invention;

FIG. 13 is an illustration of a vehicle at a fueling station using multiple communication forms for taking a payment and using a loyalty program to pay for items inside a store according to one embodiment of the invention;

FIG. 14 is an illustration of using a computing device in a vehicle to obtain a redemption balance as part of a redemption platform according to one embodiment of the invention; and

FIG. 15 is an illustration of a portable computing device at a fueling station using tokens as part of a payment system and using a loyalty program according to one embodiment of the invention.

Persons of ordinary skill in the art may appreciate that elements in the figures are illustrated for simplicity and clarity so not all connections and options have been shown to avoid obscuring the inventive aspects. For example, common but well-understood elements that are useful or necessary in a commercially feasible embodiment may often not be depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions used herein may be defined with respect to their corresponding respective areas of inquiry and study except where specific meanings have otherwise been set forth herein.

### DETAILED DESCRIPTION

At a high level, disclosed may include a process and protocol to allow a vehicle to communicate with the outside worlds using a first communication form such as WiFi and a second communication form such as Bluetooth. As a result, the communication may be more secure, more data may be transferred and more communication options may be available to the user.

The present invention may now be described more fully with reference to the accompanying drawings, which form a part hereof, and which show, by way of illustration, specific exemplary embodiments by which the invention may be practiced. These illustrations and exemplary embodiments may be presented with the understanding that the present disclosure is an exemplification of the principles of one or more inventions and may not be intended to limit any one of the inventions to the embodiments illustrated. The invention may be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods, systems, computer readable media, apparatuses, or devices. Accordingly, the present invention may take the form of an entirely hardware embodiment, an entirely software embodiment, or an embodiment combining software and hardware aspects. The following detailed description may, therefore, not to be taken in a limiting sense.

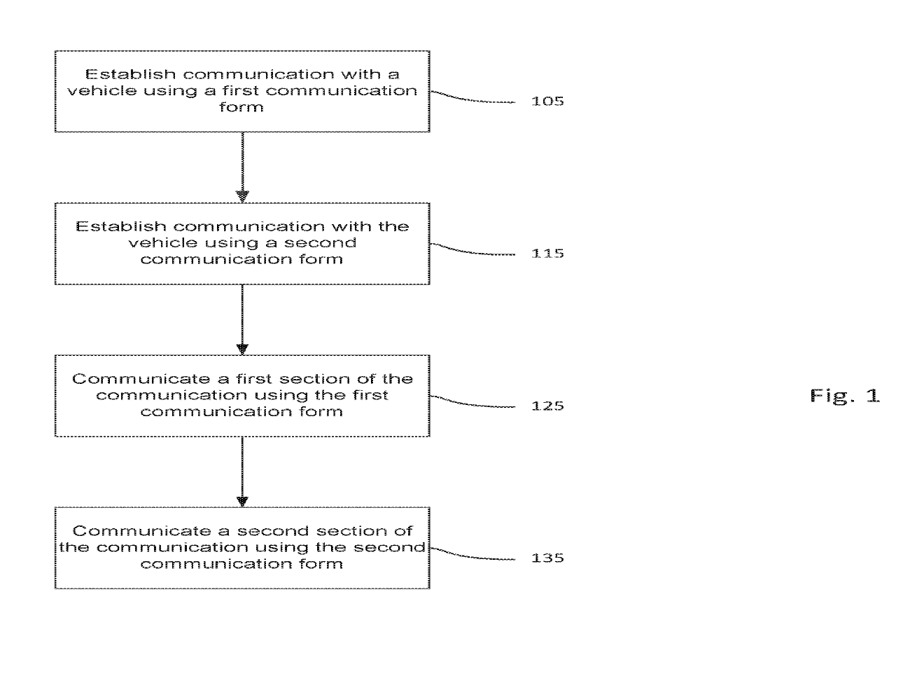

Referring to FIG. 1, a process for communicating between a vehicle and an additional communication device may be disclosed. At block 105, communication may be established with a vehicle using a first communication form. The communication may be wireless communication, such as WiFi, 802.11 based solutions, Bluetooth, infrared, NFC, or any other wireless protocol which may be appropriate to communicate data.

At block 115, communication may be established with the vehicle using a second communication form. Again, the communication may be wireless communication, such as WiFi, 802.11 based solutions, Bluetooth, infrared, NFC, or any other wireless protocol which may be appropriate to communicate data. Care may need to be taken such that the first and second communication forms do not interfere.

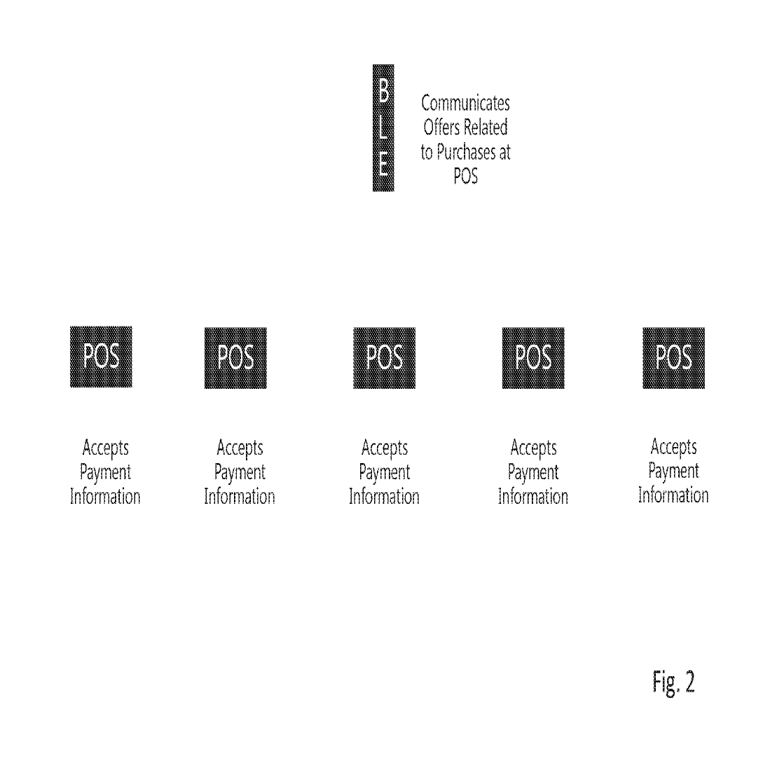

At block 125, a first section of the communication may be communicated using the first communication form or channel and at block 135 a second section of the communication may be communicated using the second communication form or channel. The communication may be separated between the forms or channels in a variety of ways. In some embodiments, one form may be used exclusively for payment related data and a second form may be used additional communications such as offers, deals, sales, advertisements, enrollments, etc. FIG. 2 may illustrate one such arrangement where point of sale (POS) devices may accept wireless payment data through near field communication (NFC) 202 and rewards or offers may be communicated over Bluetooth such as through BLE beacons 204.

In other embodiments, the payment data and the additional communication may be comingled between the two communication forms or channels. For example, a communication of 24 bits may be split into a first number of bits (8) of a payment communication may be communicated via WiFi and second number of bits (16) of a payment communication may be communicated via Bluetooth. A receiver, such as a gas station, may receive the WiFi and Bluetooth communications and may reassemble the first number of bits and second set of bits into the original 24 digits.

Further, additional bits may be split between a plurality of communication forms and the bits may be reassembled at a central receiving point. For example, in the simple 24 bit communication example, bits 1-4 may be communicated via WiFi, bits 5-16 may be communicated via Bluetooth and bits 17-24 may be communicated via an infrared signal. The various communications may also contain an indication to signify the order in which the bits should be reassembled. In a simple example, bits 1-4 may contain a “first” marker, bits 5-16 may contain a “second” marker and bits 17-24 may contain a “third” marker. The receiver may then know the order to reassemble the received bits. The last set of bits may also contain a “last” indication and a “total” indication (24 bits in total) which may be used to ensure the entire string of bits was successfully received.

As a result of the bits being broken between communication forms, it may be especially difficult to hack or steal the wireless signal. If a nefarious person intercepted one form of communication, the received message would likely be undecipherable as large sections of the message would be missing.

Further, using multiple forms of communication may result in higher communication speeds. Similar to filling a swimming pool with two hoses is faster than one, under the right conditions, using more than one form of wireless communication may be faster than a single form.

In some embodiments, a wallet application may be installed on a portable computing device and the portable computing device may be part of the vehicle. The wallet application may allow a variety of payment devices such as debit cards or credit cards to be added to the application and any of the debit or credit cards may be used to make a payment or enable a transaction. The wallet application may use tokens to ensure security of the wireless transaction.

The wallet application that is installed on a computing device that is part of the vehicle may be used to buy goods and services inside a location. For example, the wallet may use wireless communication with a POS to enable a user to buy goods inside a store even though the vehicle may be parked outside the store. Further, if one form of communication has a longer ranger, the longer range of communication may be used to enable the transaction inside the store.

By using the multiple communication channels, reward points may be made more useful. For example, it is a challenge for traditional payment networks to handle reward point as traditional payment networks are set up to handle monetary transactions. By using a second communication channel in addition to the payment network, additional options to use reward points or offers may be available.

As one example, using the second communication form or channel, the balance in a reward account may be checked. If there is a sufficient reward account balance, a notice may be communicated to the user that rewards may be used to pay for all or part of a purchase. If the user accepts the use of the reward points, the central computing device may create the necessary charges to the reward points and to the monetary account of the user.

The opportunity to use reward points may be displayed after an authorization message is communicated through a payment network or payment processing network. The charges for the monetary value may use the payment network for debit cards, credit cards, stored-value cards, etc., and the reward account charges may use a separate communication form or channel that may include reward account exchanges, loyalty program accounts, etc.

As another example, the second communication channel may be used to enroll a user in a loyalty service at the time of payment. Further the user may join the loyalty program using the computing device that is part of the vehicle. As an example, the computing device may use a display or touch screen in a vehicle to allow a user to easily type in the necessary information to establish a loyalty account.

Likewise, the display in a vehicle may be used to receive and display offers from nearby retailers that are within a threshold distance of the vehicle. As an example, a gas station may only sell gas but a donut store nearby may display offers to gas buyers using the second communication channel. Further, the user may select a good using a menu received through the second communication channel and the user may pay for the good using one or more of the communication channels. Logically, a receipt may be received and displayed in the vehicle from the first or additional retailer.

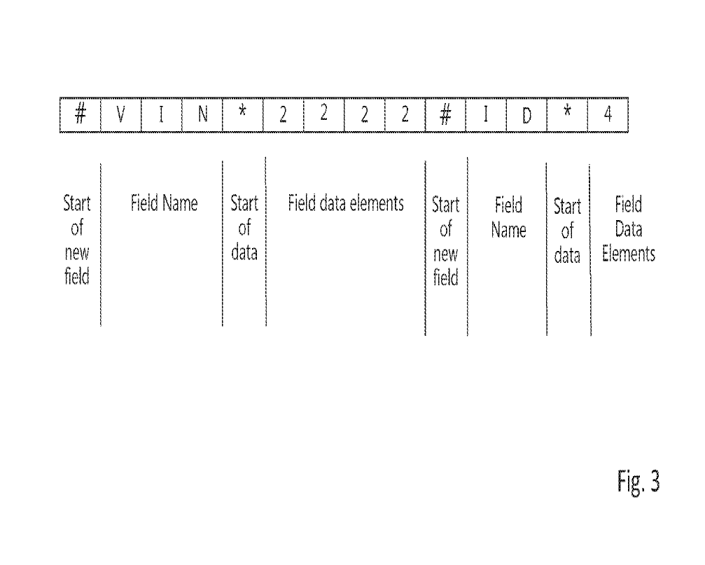

In another aspect, an extensible wireless communication payment protocol for a vehicle may be used to execute transactions using a computing device in a vehicle. FIG. 3 may illustrate a sample protocol. In one embodiment, a first character may indicate a field name 302 will follow and a variable number of field name data elements 304 that represents the field name may follow. Logically, addition fields may have their own first character and may have their own field names. For example, a second character may indicates second field data and a variable number of second field data elements may represents the second field data. In this way, the protocol is extensible and may easily accommodate additional fields which may be added in the future.

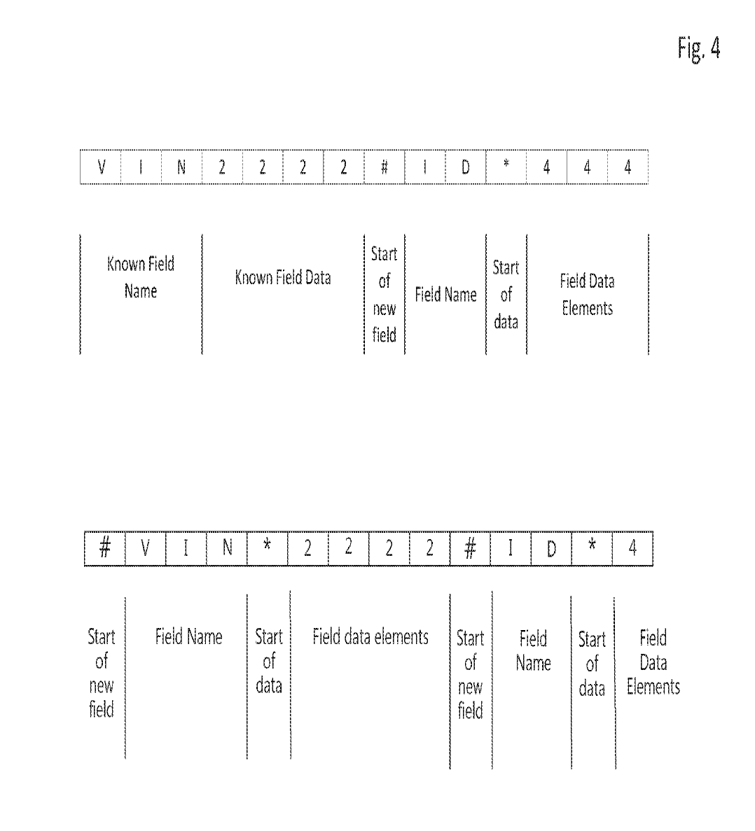

In some embodiments such as in FIG. 4, a portion of the protocol may be fixed and a portion may be extensible. For example, identification may have to be communicated to effectuate any transaction. Logically, the protocol may be created to set up a standard field and bits to represent an identification of the user, which may be represented by a vehicle. As illustrated in FIG. 4, the vehicle identification number (VIN) may be used in every transaction and may be a static part of a the protocol while a later part of the protocol may be extensible.

As mentioned earlier, the protocol may give the packets order numbers such that the packets may be communicated over different communication forms channels but may still be reconfigured by a backend system into the desire order. Thus, the protocol may also enable receiving a portion of the protocol in a first communication form and where an additional portion of the protocol is received in a second communication form.

Payment data may be used in the first communication form and reward data is used in the second communication form and the order of the packets may be noted in the protocol. Logically, the packets may be encased in additional data to accommodate the different communication forms and for error correction purposes.

A wallet application may also use the extensible protocol. The wallet app may generate the base data which may be added to packets which may be split amount the various communication forms. The wallet app may be part of the computing device in a vehicle and the vehicle computing device may utilize the extensible protocol to enable transactions through the vehicle computing system, including transactions that use tokens. The wallet application may be used through the protocol to buy goods near the location of the vehicle wherein secure and reliable communication may be established with the additional merchant.

The protocol may also be used with loyalty points and reward points. The loyalty points and rewards may be indicated as a letter in the protocol and may also be communicated wirelessly to a vehicle using a variety of communication forms. As an example, the option to use reward points if a user has sufficient reward points may be communicated as part of the protocol and the offer may come from a variety of nearby vendors as long as secure and reliable communication may be established. Similarly, a user may enroll in a loyalty program using the extensible protocol and the computing device that is part of the vehicle. Finally, receipts may also be communicated to a user using the protocol and the computing device that is part of the vehicle.

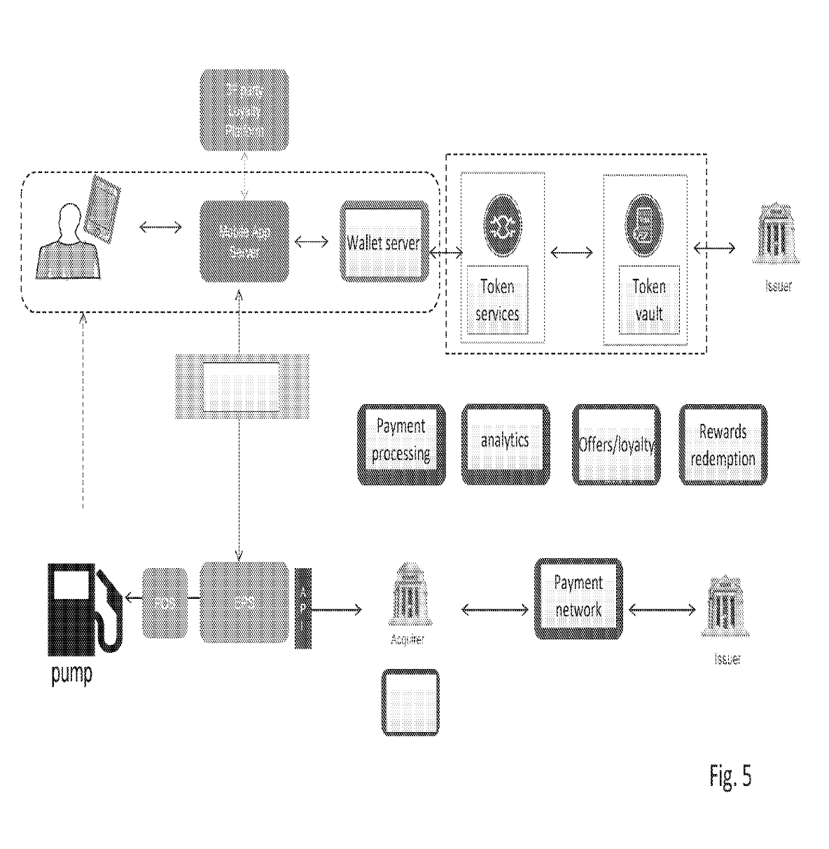

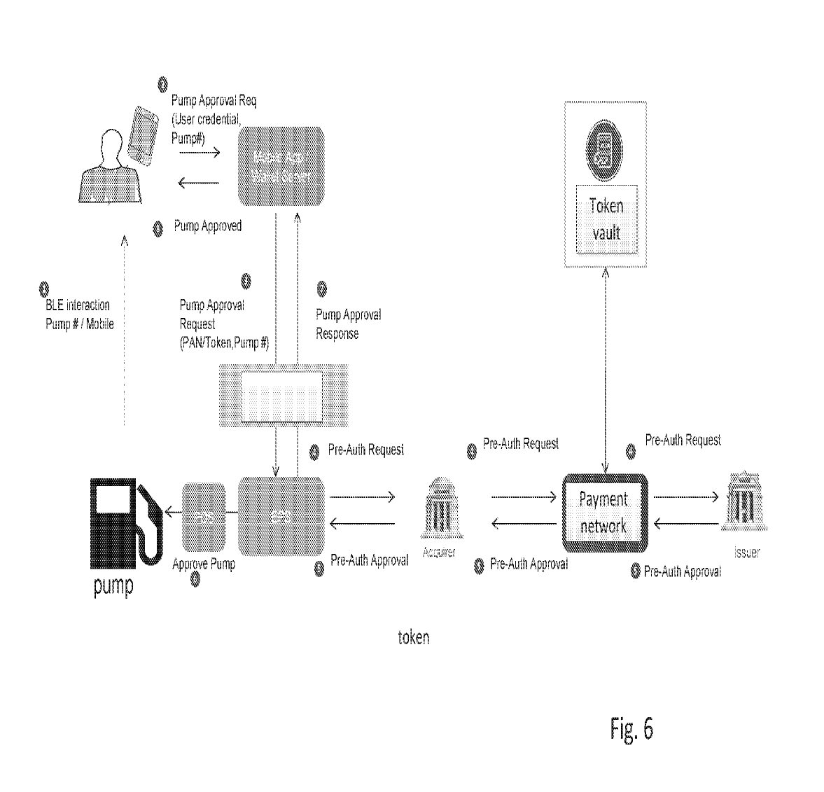

There may be an endless variety of ways to use the process and protocol. FIG. 5 may be an illustration of a vehicle 502 at a fueling station 504 taking a payment and using a loyalty program. FIG. 6 may be an illustration of a vehicle 602 at a fueling station 604 using multiple communication forms for taking a payment and using a loyalty program.

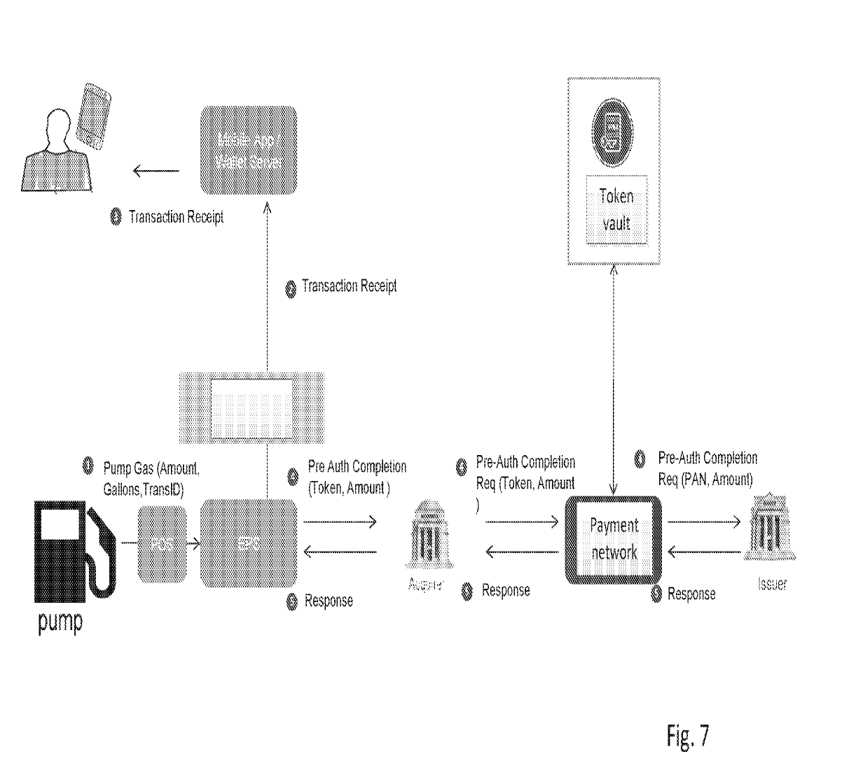

Referring again to FIG. 6, at a first state 606, an exemplary Bluetooth communication may be established between a portable communication device, which may be part of a vehicle or may be a part of another device such as a smart phone, and a point of sale device which may be a pump. The communication may contain payment data such a personal account number or it may contain user credential data to establish payments based on tokens which may come from a wallet server. In the second step 608, the user credential data may be communicated to a mobile app/wallet server which may verify the user credentials. At the third step 610, a payment approval request may be communicated using either the personal account number or a token or even pump related information if the user is at a fueling station. The payment approval request may be communicated to an electronic payment system (EPS) which may communicate the payment approval pre-authorization request 612 to an acquirer 614 which may utilize a payment network 616 such as VisaNet to communicate the pre-authorization request to a payment device issuer 618. Assuming the pre-authorize request is approved, an approval 620 will be communicated to the payment network 616, to the acquirer 614 and then to the point of sale device which may be a fueling pump. The approval 620 also may be communicate to a mobile application if the mobile application was part of the transaction and the approval 620 may be displayed on the portable computing device which may be part of a vehicle. FIG. 7 may be an illustration of a vehicle at a fueling station using tokens as part of a payment system and using a loyalty program but a second communication channel such as Bluetooth may not be used which may limit the additional data, such as loyalty data or offer data, which may be communicated to a user.

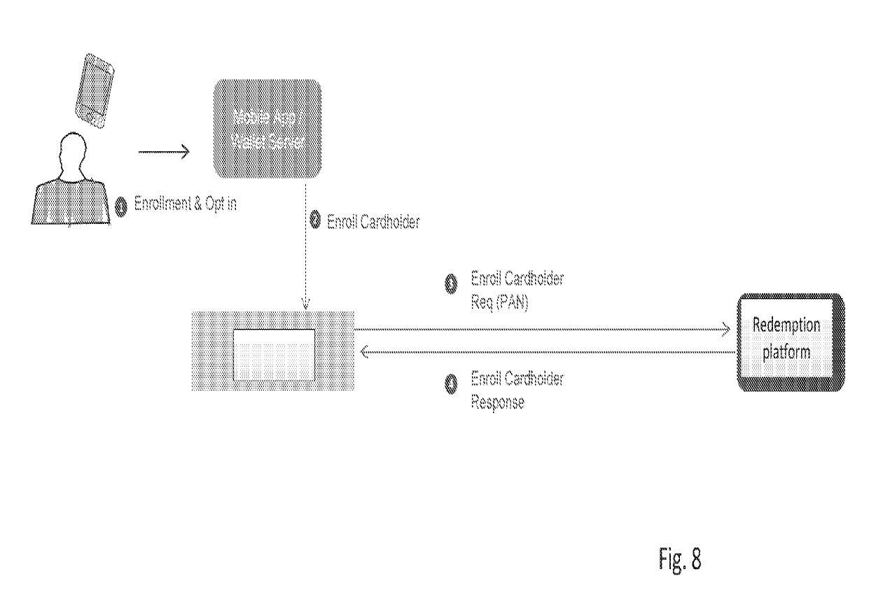

FIG. 8 may be an illustration of using a computing device in a vehicle to enroll in a redemption platform. At a first block 802, a user may opt in to enrolling in a loyalty or offer program. A user may use a portable computing device such as a smart phone or a computing device in a vehicle to enter the relevant enrollment data at the second block 804. At the third block 806, the card holder enrollment data may be communicated to a data processing operation which may communicate the enrollment data such as personal account number to a redemption platform. The redemption platform may analyze the enrollment information and at the fourth block 808, may communicate the response to the enrollment request to the portable computing device of the user. As a result, a user may be able to enroll in a loyalty program at the point of sale and the enrollment may use a second communication channel such as Bluetooth, WiFi or the like.

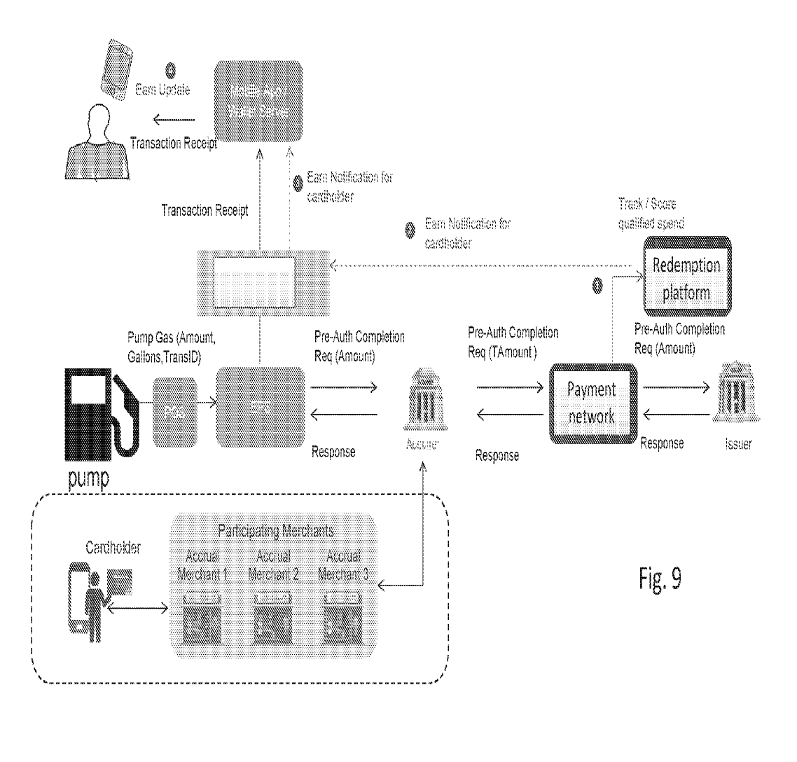

The FIG. 9 may be an illustration of a vehicle at a fueling station using a payment system and using a loyalty program. At block 1, it is assumed a user has already made an authorization request. Merchants that are part of a loyalty program may report qualifying purchases to an acquirer which may communicate the qualifying purchases to a redemption platform. The qualifying purchases may be tracked and the status may be determined in a redemption platform at block two. The various earning levels may be noted and communicated to the cardholder at block three and the notifications may be provided to the cardholder through a mobile application or wallet server at block 4.

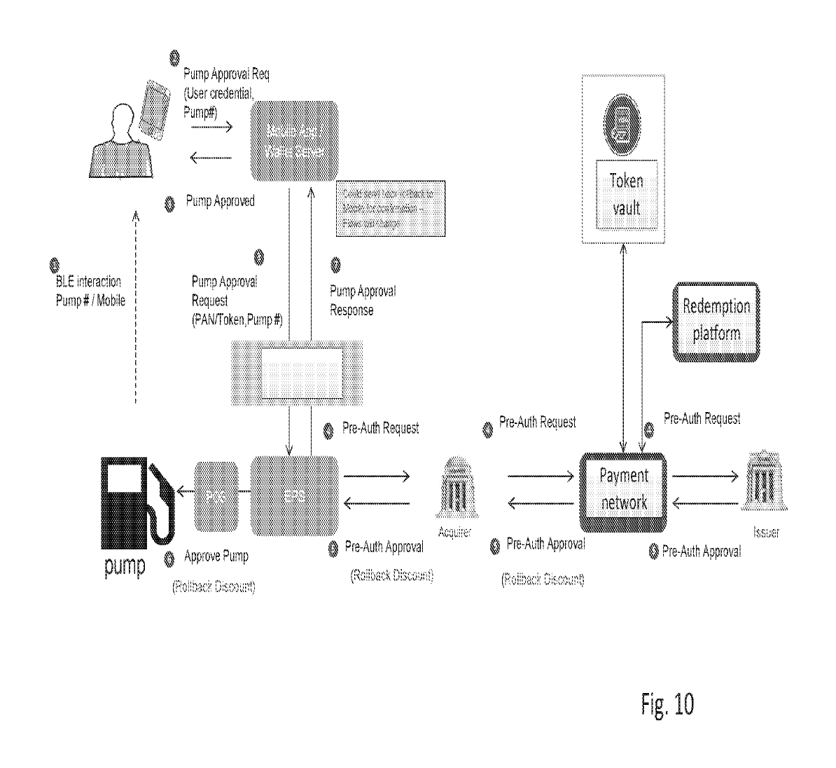

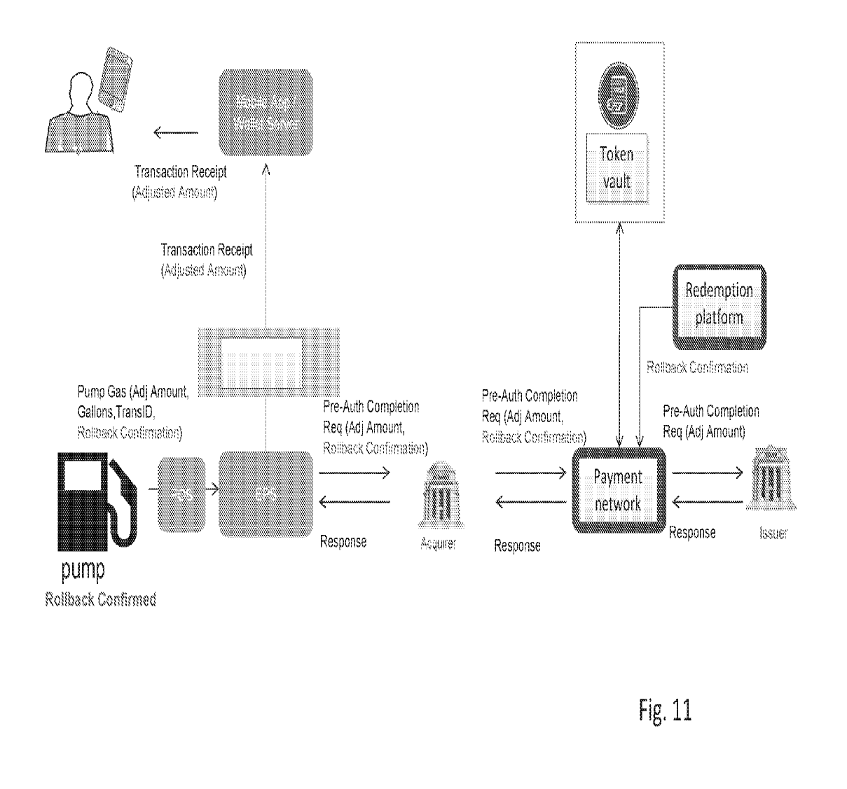

FIG. 10 may be another illustration of a vehicle at a fueling station using multiple communication forms for taking a payment and using a loyalty program. Specific to FIG. 10, a discount from a loyalty program may be determined and communicated to the user through a mobile application. FIG. 11 may be a further illustration of a vehicle at a fueling station using multiple communication forms for taking a payment and using a loyalty program to pay for a purchase at an earned discount.

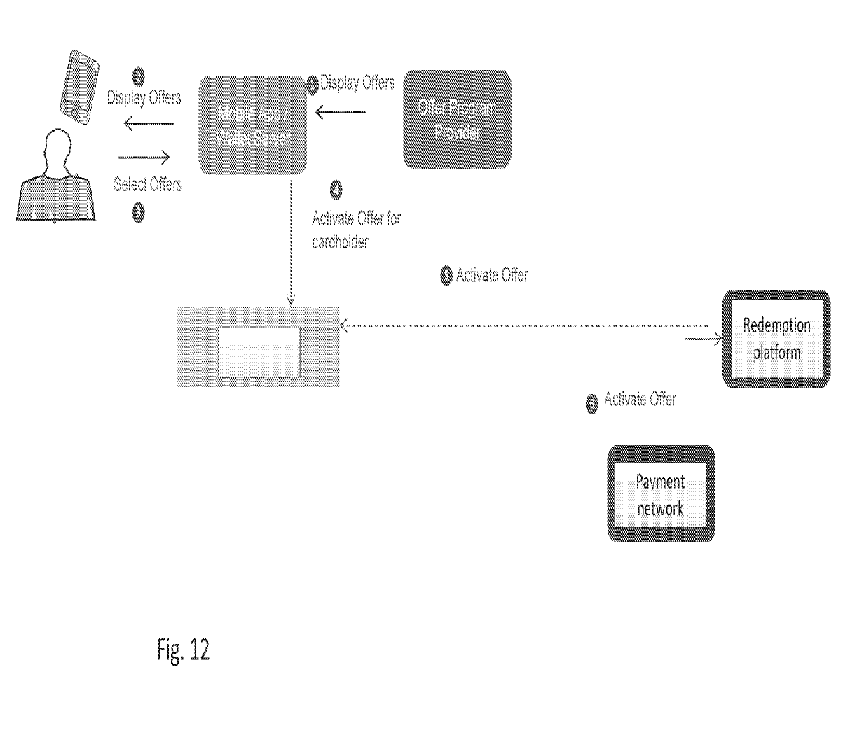

FIG. 12 may be yet another alternative illustration of using a computing device in a vehicle to use offers as part of a redemption platform. At a first block, an offer may be received at a portable computing device which may be part of a vehicle and it may be displayed to a user at the second block. A user may use the portable computing system to select an offer and the selection may be communicated to a data processor where the offer may be activated at block five. The payment network may be used to activate the offer at block six which may be communicated to the redemption platform.

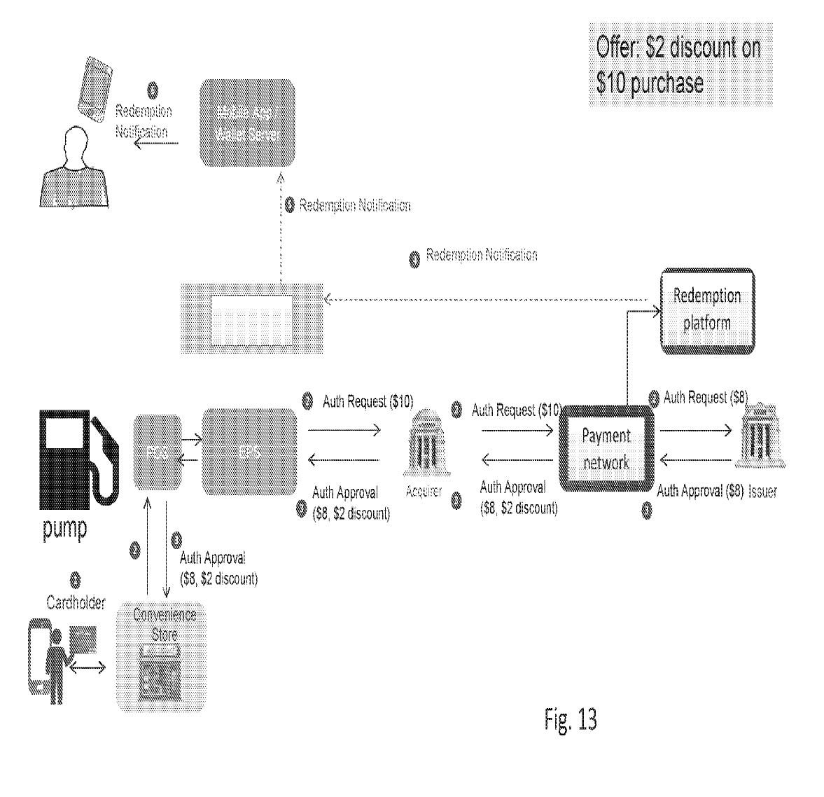

FIG. 13 may be an illustration of a vehicle at a fueling station using multiple communication forms for taking a payment and using a loyalty program to pay for items inside a store. Specifically, a discount in a store may use a redemption platform to execute an offer and communicate the use of the offer to a computing device of a user.

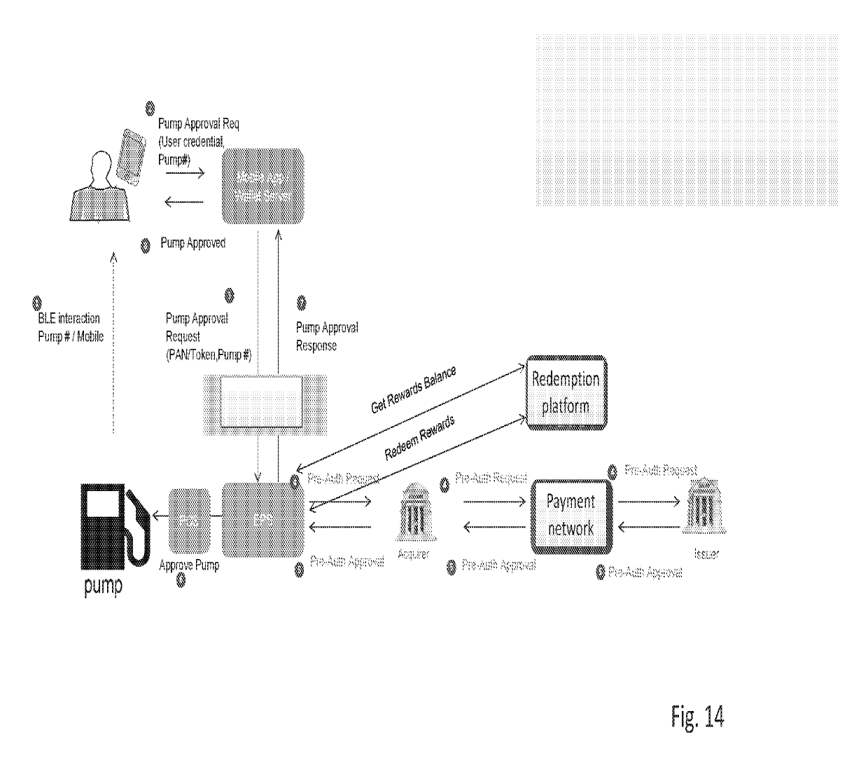

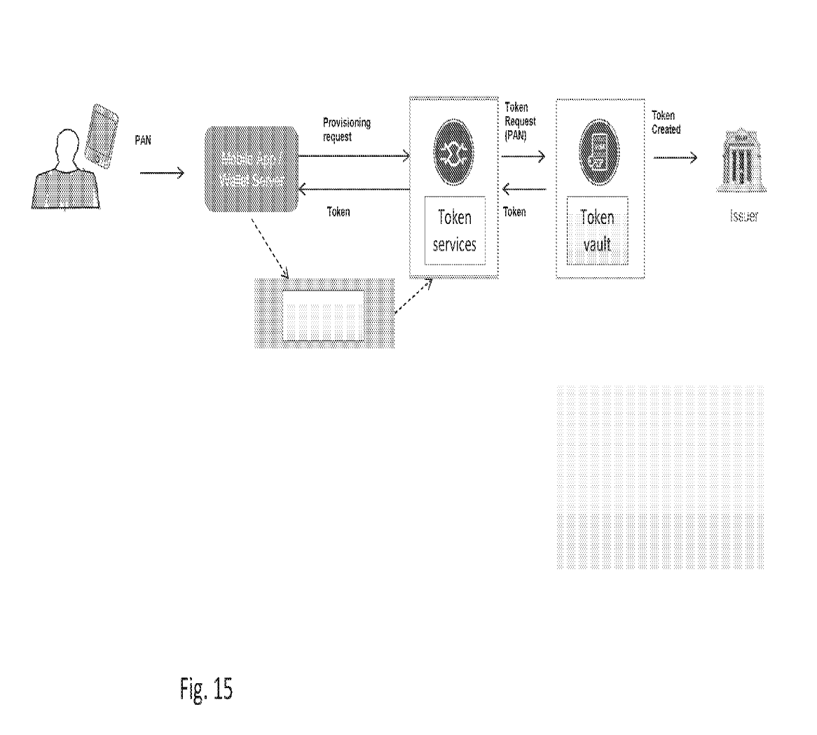

FIG. 14 may be an illustration of using a computing device in a vehicle to obtain a redemption balance as part of a redemption platform by using multiple communication forms. Specifically, Bluetooth may be used to obtain information on reward balances and available rewards. The rewards may be used through a traditional payment system as previously described which may interface with a redemption platform to provide rewards at the time of a purchase. Finally, FIG. 15 may be an illustration of a portable computing device at a fueling station using tokens as part of a payment system and using a loyalty program.

The computers and servers in FIGS. 1-15 may be general purpose computers that may have, among other elements, a microprocessor (such as from the Intel Corporation, AMD or Motorola); volatile and non-volatile memory; one or more mass storage devices (i.e., a hard drive); various user input devices, such as a mouse, a keyboard, or a microphone; and a video display system. The computers and servers in FIG. 1 may be running on any one of many operating systems including, but not limited to WINDOWS, UNIX, LINUX, MAC OS, or Windows (XP, VISTA, etc.). It is contemplated, however, that any suitable operating system may be used for the present invention. The computers and servers in FIG. 1 may be a cluster of web servers, which may each be LINUX based and supported by a load balancer that decides which of the cluster of web servers should process a request based upon the current request-load of the available server(s).

Computers (although not shown specifically and in an independent form) and servers in FIGS. 5-15 are interconnected despite no direct lines shown connecting to among them. The connections or lines may represent networks, including the Internet, WAN, LAN, Wi-Fi, other computer networks (now known or invented in the future), and/or any combination of the foregoing. It should be understood by those of ordinary skill in the art having the present specification, drawings, and claims before them that networks may connect the various components over any combination of wired and wireless conduits, including copper, fiber optic, microwaves, and other forms of radio frequency, electrical and/or optical communication techniques. It should also be understood that any network may be connected to any other network in a different manner. The interconnections between computers and servers in system 100 are examples. Any device depicted in FIGS. 5-15 may communicate with any other device via one or more networks.

The system may include additional devices and networks beyond those shown. Further, the functionality described as being performed by one device may be distributed and performed by two or more devices. Multiple devices shown in FIGS. 5-15 may also be combined into a single device, which may perform the functionality of the combined devices.

The various participants and elements described herein may operate one or more computer apparatuses to facilitate the functions described herein. Any of the elements in the above-described Figures, including any servers, user terminals, or databases, may use any suitable number of subsystems to facilitate the functions described herein.

Any of the software components or functions described in this application, may be implemented as software code or computer readable instructions that may be executed by at least one processor using any suitable computer language such as, for example, Java, C++, or Perl using, for example, conventional or object-oriented techniques.

The software code may be stored as a series of instructions or commands on a non-transitory computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus and may be present on or within different computational apparatuses within a system or network.

It may be understood that the present invention as described above can be implemented in the form of control logic using computer software in a modular or integrated manner. Based on the disclosure and teachings provided herein, a person of ordinary skill in the art may know and appreciate other ways and/or methods to implement the present invention using hardware, software, or a combination of hardware and software.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention. A recitation of “a”, “an” or “the” is intended to mean “one or more” unless specifically indicated to the contrary. Recitation of “and/or” is intended to represent the most inclusive sense of the term unless specifically indicated to the contrary.

One or more of the elements of the present system may be claimed as means for accomplishing a particular function. Where such means-plus-function elements are used to describe certain elements of a claimed system it will be understood by those of ordinary skill in the art having the present specification, figures and claims before them, that the corresponding structure is a general purpose computer, processor, or microprocessor (as the case may be) programmed to perform the particularly recited function using functionality found in any general purpose computer without special programming and/or by implementing one or more algorithms to achieve the recited functionality. As would be understood by those of ordinary skill in the art that algorithm may be expressed within this disclosure as a mathematical formula, a flow chart, a narrative, and/or in any other manner that provides sufficient structure for those of ordinary skill in the art to implement the recited process and its equivalents.

While the present disclosure may be embodied in many different forms, the drawings and discussion are presented with the understanding that the present disclosure is an exemplification of the principles of one or more inventions and is not intended to limit any one of the inventions to the embodiments illustrated.

The present disclosure provides a solution to the long-felt need described above. In particular, systems and methods described herein may be configured to facilitate compliance with a drug discount program. Further advantages and modifications of the above described system and method will readily occur to those skilled in the art. The disclosure, in its broader aspects, is therefore not limited to the specific details, representative system and methods, and illustrative examples shown and described above. Various modifications and variations can be made to the above specification without departing from the scope or spirit of the present disclosure, and it is intended that the present disclosure covers all such modifications and variations provided they come within the scope of the following claims and their equivalents.

1. A computerized process for communicating between a vehicle and an additional communication device comprising:
establishing communication with a vehicle using a first communication form;
establishing communication with a vehicle using a second communication form;
communicating a first section of the communication using the first communication form; and
communicating a second section of the communication using the second communication form.

2. The computerized process of claim 1, further comprising using a wallet app as part of the transaction that generates the communication.

3. The computerized process of claim 2, wherein the wallet app is installed on a computing device that is part of the vehicle.

4. The computerized process of claim 1, wherein the wallet app installed on the vehicle is used to buy goods and services inside a location.

5. The computerized process of claim 1, further comprising payment data is used in the first communication form and reward data is used in the second communication form.

6. The computerized process of claim 5, wherein the reward data comprises reward points for paying for fuel, wherein the reward points are tracked through a payment network.

7. The computerized process of claim 6, wherein in response to the reward points being over a threshold, the reward points are offered for use as part of an authorization message.

8. The computerized process of claim 1, further comprising receiving a loyalty service enrollment from users using the computing device that is part of the vehicle.

9. The computerized process of claim 8, wherein the users at the computing device receive offers for a location within a threshold distance of the vehicle using the second communication form.

10. The computerized process of claim 9, wherein one of the offers comprises a separate retailer than a nearest retailer.

11. The computerized process of claim 9, wherein the users receive receipts for a location within the threshold distance of the vehicle using the second communication form.

12. The computerized process of claim 5, wherein the payment data uses tokens from a token service.

13. An extensible wireless communication payment protocol for a vehicle comprising
a first character that indicates a field name to follow;
a variable number of field name data elements that represents the field name;
a second character that indicates second field data;
a variable number of second field data elements that represents the second field data;
wherein a portion of the protocol is received in a first communication form and wherein an additional portion of the protocol is received in a second communication form.

14. The wireless communication payment protocol of claim 13, further comprising using a wallet app as part of a transaction that generates the communication.

15. The wireless communication payment protocol of claim 14, wherein the wallet app is installed on a computing device that is part of the vehicle.

16. The wireless communication payment protocol of claim 14, wherein the wallet app installed on the vehicle is used to buy goods and services inside a location.

17. The wireless communication payment protocol of claim 14, further comprising payment data is used in the first communication form and reward data is used in the second communication form.

18. The wireless communication payment protocol of claim 17, the reward data comprises reward points for paying for fuel, wherein the reward points are tracked through a payment network.

19. The wireless communication payment protocol of claim 17, wherein in response to the reward points being over a threshold, the reward points are offered for use as part of an authorization message.

20. The wireless communication payment protocol of claim 17, further comprising receiving a loyalty service enrollment from users using the computing device that is part of the vehicle.

21. The wireless communication payment protocol of claim 20, wherein the users at the computing device receive offers for a location within a threshold distance of a vehicle using the second communication form.

22. The wireless communication payment protocol of claim 21, wherein one of the offers comprises a separate retailer than a nearest retailer.

23. The wireless communication payment protocol of claim 13, wherein the users receive receipts for a location within the threshold distance of the vehicle using the second communication form.

24. The wireless communication payment protocol of claim 13, wherein the payment data uses tokens from a token service.
